(19) United States
(12) Patent Application Publication
(10) Pub. No.: US 2004/0007976 A1
(43) Pub. Date: Jan. 15, 2004

(54) High efficiency electrode structure for plasma display panel

(76) Inventors: Hsu-Pin Kao, Ping Chen City (TW); Cing-Chung Cheng, Ping Chen City (TW); Sheng-Chi Lee, Taipei (TW); Kuang-Lang Chen, Chungli City (TW)

Correspondence Address: BAKER & BOTTS, 30 ROCKEFELLER PLAZA, NEW YORK, NY, 10112

(21) Appl. No.: 10/192,356

(22) Filed: Jul. 9, 2002

(51) Int. Cl. H01J 17/49

(52) U.S. Cl. 313/582

(57) ABSTRACT

A high efficiency electrode structure for a plasma display panel is described. The high efficiency electrode structure mainly comprises a comb electrode which including a main line across luminant units in row and a plurality of branches perpendicularly expanded from the main line and located between the luminant units. A transparent electrode parallel to the main line of the comb electrode is coupled to the end of the branches of the comb electrode. The end of the branches approximates the discharge center of the luminant units. The discharge electric field of luminant unit is more uniform and the sustaining voltage is lowered.

### FIELD OF THE INVENTION

The present invention relates to a plasma display panel (PDP), and more particularly to an electrode structure for a color PDP, which is high in power efficiency and in display contrast.

### BACKGROUND OF THE INVENTION

Since the field of multimedia applications is developing quickly, the user has a great demand for entertainment equipment. Conventionally, the cathode ray tube (CRT) display, which is a species of monitor, is commonly used. However, the cathode ray tube display does not meet the needs of multimedia technology because of having a large volume. Therefore, many flat panel display techniques such as liquid crystal display (LCD), plasma display panel (PDP), and field emission display (FED) have been recently developed. These display techniques can manufacture a thin, light, short and small monitor, and thus these techniques are going to be the mainstream technology for the future. In these techniques, the plasma display panel (PDP) is attracting attention in the field of displays as a full-color display apparatus having a large size display area and is especially popularly utilized in a large size television or an outdoor display panel. This is because of its capability of a high quality display resulting from the fact that it is of a self-light emitting type with a wide angle of visibility and high speed of response as well as it is suited to upsizing since its simplicity in the manufacturing process.

A color PDP is a display in which ultraviolet rays are produced by gas discharge to excite phosphors so that visible lights are emitted therefrom to perform a display operation. Depending upon a discharge mode, the color PDP is classified into an alternating current (AC) or a direct current (DC) type. In the AC type PDP, an electrode is covered with a protective layer. The AC type PDP has such characteristics that it inherently has a long life and a high brightness. Therefore, the AC type PDP is commonly superior to the DC type PDP in luminance, luminous efficiency and lifetime. Generally, a 3-electrode type PDP including a common electrode, a scan electrode and an address electrode is employed in the AC type PDP. The 3-electrode type is directed to a surface discharge type and is switched or sustained based on a voltage applied to the address electrode installed at a lateral surface of a discharge cell.

In particular, the common and scan electrodes formed on an image display side substrate are formed of a transparent electrode made of a glass material for implementing a certain transmittivity of visual ray. A non-transparent electrode having a small width, generally referred as a bus electrode, is used integrally with respect to the transparent electrodes. The transparent electrode material is a semiconductor typically formed of ITO (e.g., a mixture of indium oxide In₂O₃ and tin oxide SnO₂). The conductivity of the transparent electrode is low in comparison with that of metal, and therefore a narrow width and fine conductive layer is added as the bus electrode on the transparent electrode to enhance its conductivity.

When an address discharge voltage is supplied to the scan electrode and a corresponding address electrode, an address discharge is generated between the scan electrode and the address electrode. An electric field is formed in the interior of a corresponding luminant unit, the electrons of the discharge gases are accelerated, and the accelerated electrons collide with ions. At this time, the ionized electrons collide with neutron particles, so that the neutron particles are ionized into electrons and ions at high speed, whereby discharge gas becomes a plasma state, and a vacuum ultraviolet ray is formed.

When a discharge sustaining voltage generally higher than 150V is supplied to the common electrode of the light emitting cell, a sustaining discharge is generated between the scan electrode and the common electrode for thereby sustaining a light emitting operation of the ruminant units. However, the transparent electrode mentioned above is high in sheet resistance. In case of a large panel or a high-definition panel, an electrode resistance will become as high as several tens kilo-ohms (kΩ) or more. This may result in insufficient pulse rise or voltage drop of the pulse voltage applied to the transparent electrode. The driving margin is also limited and thereby cannot increase the operation speed. In this event, it is difficult to drive the color PDP. Moreover, the wider and high resistant transparent electrode consumes lots of power for sustaining discharge, such that the performance of the color PDP cannot be improved.

### SUMMARY OF THE INVENTION

It is an object of the present invention to provide a comb electrode having a plurality of branches approximated to the discharge center of the luminant units to provide uniform electric field, and increase the driving margin in a high speed of signal input.

It is another object of the present invention to provide a comb electrode composed of anti-reflective material and disposed on the barrier ribs between the luminant units to cover the high reflective barrier ribs and improve the display contrast.

It is a yet object of the present invention to provide a comb electrode in conjunction with a parallel transparent electrode coupled to the end of the branches of the comb electrode. The width of the transparent electrode can be narrower so that the power consumption of the transparent electrode while discharge sustaining can be decreased.

Therefore, the present invention provides a discharge electrode structure for a plasma display panel. The discharge electrode structure is formed on a substrate and connected to a signal supply device to control gas discharge of luminant units in row. The discharge electrode structure comprises a comb electrode and a transparent electrode. The comb electrode has a main line across the ruminant units and a plurality of branches perpendicularly expanded from the main line and located on the barrier ribs between the luminant units. The tail end of the branches approximates the discharge center of the luminant units. The comb electrode can combine with variant transparent electrode to obtain high power performance.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic top view of a comb electrode for a plasma display panel according to one preferred embodiment of the present invention;

FIG. 2 is a schematic top view of a comb electrode matched with a narrower transparent electrode according to another preferred embodiment of the present invention;

FIG. 3 is a schematic top view of a comb electrode matched with a transparent electrode having expanding regions in conjunction of the comb electrode according to a yet preferred embodiment of the present invention;

FIG. 4 is a schematic top view of a comb electrode matched with a transparent electrode having an arc profile at one side according to a modified preferred embodiment of the present invention;

FIG. 5 is a schematic perspective view of a plasma display panel of which having a comb electrode according to the present invention; and

FIG. 6 is an experimental diagram in comparison of a convention bus electrode and a comb electrode of the present invention.

### DETAILED DESCRIPTION OF THE PREFERRED EMBODIMENT

The present invention provides a high efficiency electrode structure for a plasma display panel. The electrode structure mainly comprises a comb electrode having a plurality of branches located between the luminant units and approximated to the discharge center of the luminant units. Therefore, uniform electric field can be provided, and the driving margin of the luminant units can be increased. The width of the transparent electrode can be narrower, and variant design of the transparent electrode can be applied to the comb electrode so that power consumption can be lowered.

FIG. 1 is a schematic top view of a discharge electrode structure for a plasma display panel according to one preferred embodiment of the present invention. Referring to FIG. 1, the discharge electrode structure comprises a comb electrode 14 and a transparent electrode 12. For a 3-electrode structure, a pair of comb electrode 14 and a pair of transparent electrode 12 are used and disposed in opposite of the luminant units, respectively. The comb electrode 14 includes a main line 142 passing through each one of the luminant units in row. The main line 142 is connected to a signal supply device (not shown) to control gas discharge of a specific luminant unit. The ruminant units are separated by barrier ribs 24, for example, a plurality of parallel strips, thereby the luminant units are formed therebetween. A plurality of branches 144 are expanded from the main line 142 and located between the luminant units. Generally, the branches 144 are aligned to the barrier ribs 24. Therefore, the opaque branches 144 will not hide the light emitted from the luminant units. A material of the main line 142 and the branches 144 can be selected from the group consisting of aluminum, cobalt, silver, molybdenum, chromium, tantalum, tungsten, iron, copper, and an alloy thereof. Moreover, the main line 142 and the branches 144 of the comb electrode 14 are preferably made of a conductive anti-reflective material, such as black silver. The low reflective comb electrode 14 assists in contrast by eliminating reflective light since the underneath barrier rib 24 is typically made of a high reflective material.

The tail end of the branches 144 approximates neighboring discharge centers of luminant unit where the discharge center is between a pair of transparent electrodes 12. The resistance of the comb electrode 14 is lower than the transparent electrode 12. By utilizing the comb electrode 14 that approximated to the discharge center, the electric field generated in the luminant units will be more uniform, and thus obtained uniform emitting light. The voltage dropping in y-direction occurred at the edge of the transparent electrode 12 neighboring the discharge center can be decreased. Moreover, since the comb electrode 14 is closer to the discharge center than a conventional bus electrode, the driving margin of the plasma display panel can be widened, and this is also helpful to high speed signal input during the driving operation.

Referring to FIG. 1 again, a broad transparent electrode 12 is formed on the comb electrode 14, which the transparent electrode 12 is a bar covering the main line 142 and branches 144. Each of the branches 144 located between the ruminant units aligns the underneath barrier ribs 24. A black strip structure 30 is commonly formed on a non-luminant region between the luminant units in different rows for sheltering from a light thereunder.

FIG. 5 is a schematic perspective view of a plasma display panel of which having a comb electrode of the present invention. Referring to FIGS. 1 and 5 simultaneously, the plasma display panel at least comprises a front substrate 10 and a back substrate 20. A plurality of parallel arranged address electrodes 22 are formed on the back substrate 20, and a dielectric layer 28 is formed over the substrate 20 to cover the address electrodes 22. A plurality of parallel arranged barrier ribs 24 respectively disposed between the address electrodes 22 are formed on the dielectric layer 28. Of course, variant structure of the barrier ribs 24 can be employed, but not limited to strip-like barrier ribs 24 as shown in FIG. 5. A fluorescent layer 26 is coated over the exposed surface of the luminant units between the barrier ribs. In the interior of the front substrate 10, a plurality of transparent electrodes 12 is formed thereon. A pair of the transparent electrodes 12 including an X electrode and an Y electrode is located on the luminant units in row. Each of the transparent electrodes 12 has a comb electrode 14 as described above. A dielectric layer 16 and a protective layer 18 are formed to cover the comb electrodes 14 and the transparent electrodes 12.

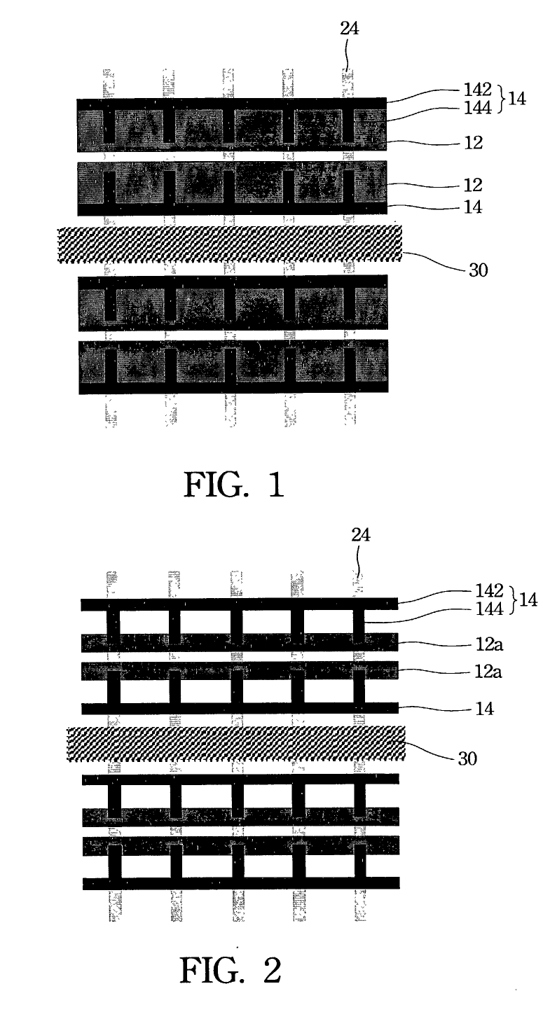

The comb electrode 14 of the present invention also can be applied to variant kinds of transparent electrode under the spirit of the present invention. Referring to FIG. 2, a comb electrode 14 including a main line 142 and a plurality of branches 144 located on the barrier ribs 24 between the luminant units is produced. A narrower transparent electrode 12a like a liner strip is coupled to the end of the branches 144 of the comb electrode 14. The width d of the transparent electrode 12a is greatly shrunk, and is narrower than that of conventional transparent electrode. Therefore, the driving current for discharge sustaining is decreased since the area of the transparent electrode 12a is smaller. The power consumption for discharge sustaining is therefore decreased while performing driving operation.

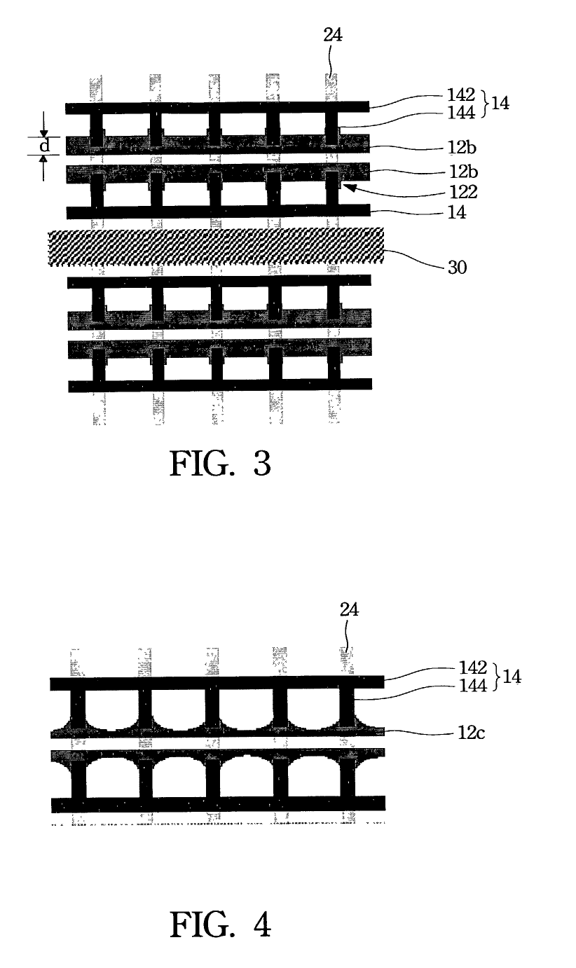

The transparent electrode 12a also can be modified to other shapes. Referring to FIG. 3, the transparent electrode 12b is similar to the transparent electrode 12a of FIG. 2. The transparent electrode 12b has an expanded region 122 coupled to the branches 144 to increase the overlay area. The expanded region 122 increases the process window while fabricating the comb electrode 14 and the transparent electrode 12b.

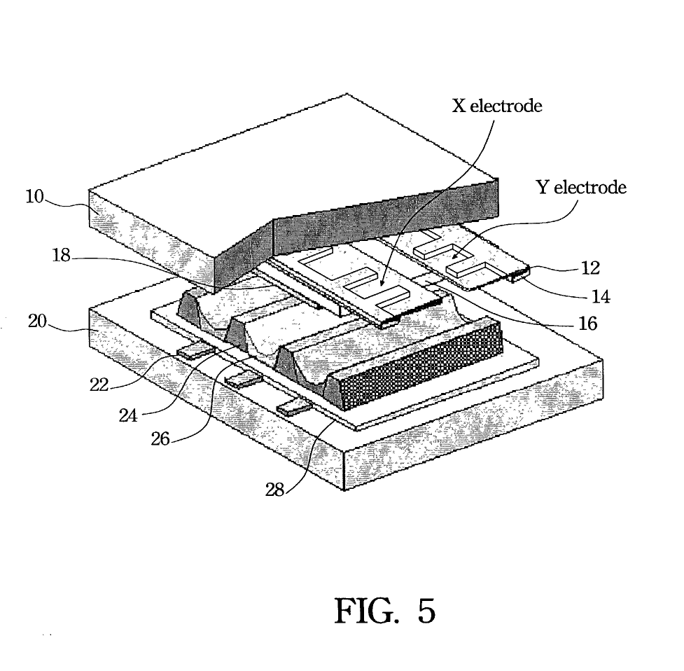

Referring to FIG. 4, the transparent electrode 12c is a modified shape according to one preferred embodiment of the present invention. The edge of the transparent electrode 12c is designed to an arch of which the expanded portion is coupled to the branches 144 so that the overlay region between the comb electrode 14 and the transparent electrode ¹2c is increased.

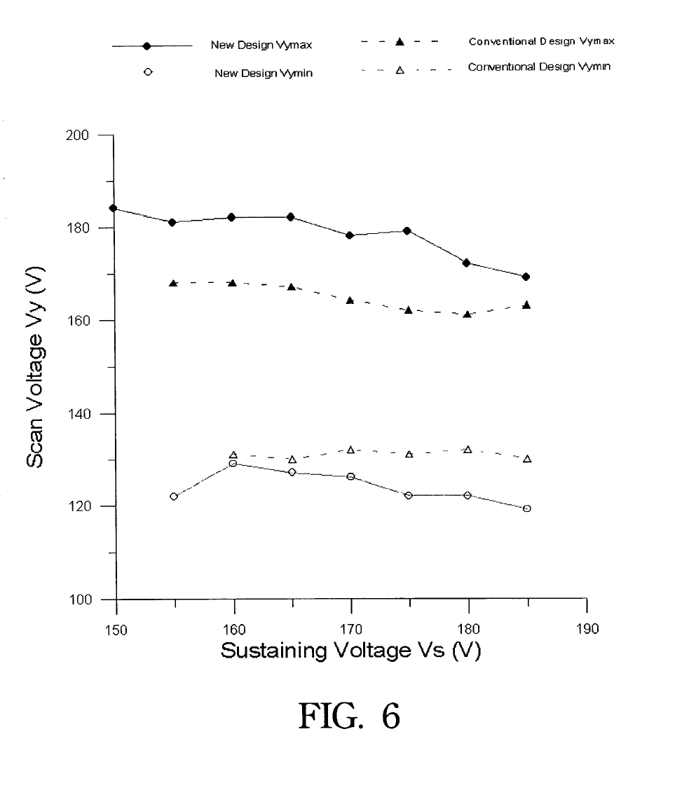

In order to signalize the advantage of the comb electrode of the present invention, comparison driving margins between the comb electrode of the present invention and conventional bus electrode is tested. FIG. 6 shows the driving margins for new and conventional luminant structures. The driving margin of the present invention is indicated by circle mark, and that of conventional bus electrode is indicated by triangle mark. It is apparent that under the same sustaining voltage Vs, the maximum scan voltage Vymax is increased and the minimum scan voltage Vymin is decreased. Therefore, the wider driving margin and the lower sustaining voltage are obtained by adopting the comb electrode of the present invention.

According to above descriptions, the present invention provides a discharge electrode structure for a plasma display panel of which having a comb electrode. The comb electrode can provide uniform electric field and wider driving margin in a high speed operation. The comb electrode can be made of an anti-reflective material and the branches of the comb electrode can be disposed on the barrier ribs between the luminant units to cover the high reflective barrier ribs and improve the display contrast. Smaller transparent electrodes can be adopted into the discharge electrode structure to reduce power consumption of the transparent electrode.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A discharge electrode structure for a plasma display panel formed on a substrate being connected to a signal supply device to control gas discharge of a plurality of luminant units in row, comprising:
a comb electrode connected to said signal supply device having a main line across said ruminant units, and a plurality of branches perpendicularly expanded from said main line and located between said luminant units; and
a transparent electrode parallel to said main line of said comb electrode and coupled to the end of said branches of said comb electrode.

2. The structure according to claim 1, wherein said comb electrode is made of a conductive anti-reflective material.

3. The structure according to claim 1, wherein a material of said comb electrode is selected from the group consisting of aluminum, cobalt, silver, molybdenum, chromium, tantalum, tungsten, iron, copper and the combination thereof.

4. The structure according to claim 1, wherein the end of said branches approximates the discharge center of said luminant units.

5. The structure according to claim 1, wherein a material of said transparent electrode comprises indium tin oxide.

6. The structure according to claim 1, wherein said transparent electrode comprises a bar covered said main line and said branches.

7. The structure according to claim 1, wherein said transparent electrode comprises a linear strip coupled to the end said branches.

8. The structure according to claim 1, wherein said transparent electrode comprises a strip having an expanded region coupled to said branches.

9. The structure according to claim 1, wherein said transparent electrode comprises a strip having an arch edge coupled to said branches.

10. A plasma display panel comprising:
a pair of substrates;
a plurality of barrier ribs disposed between said pair of substrates to form a plurality of ruminant units therein;
a pair of comb electrodes disposed on said barrier ribs, each comb electrode comprising a main line across said ruminant units in row, and a plurality of branches perpendicularly expanded from said main line and located between said luminant units; and
a pair of transparent electrodes parallel to said main line of said comb electrode and coupled to the end of said branches of said comb electrode.

11. The plasma display panel according to claim 10, wherein said comb electrode is made of a conductive anti-reflective material.

12. The plasma display panel according to claim 10, wherein a material of said comb electrode is selected from the group consisting of aluminum, cobalt, silver, molybdenum, chromium, tantalum, tungsten, iron, copper and the combination thereof.

13. The plasma display panel according to claim 10, wherein the end of said branches approximates the discharge center of said ruminant units.

14. The plasma display panel according to claim 10, wherein a material of said transparent electrode comprises indium tin oxide.

15. The plasma display panel according to claim 10, wherein said transparent electrode comprises a bar covered said main line and said branches.

16. The plasma display panel according to claim 10, wherein said transparent electrode comprises a linear strip coupled to the end said branches.

17. The plasma display panel according to claim 10, wherein said transparent electrode comprises a strip having an expanded region coupled to said branches.

18. The plasma display panel according to claim 10, wherein said transparent electrode comprises a strip having an arch edge coupled to said branches.

19. A comb electrode for a plasma display panel connected to a signal supply device to control gas discharge of a plurality of luminant units in row, comprising:
a main line connected to said signal supply device across said luminant units; and
a plurality of branches perpendicularly expanded from said main line and located between said ruminant units.

20. The comb electrode according to claim 19, wherein said main line and said branches is made of a conductive anti-reflective material.

21. The comb electrode according to claim 19, wherein a material of said main line and said branches is selected from the group consisting of aluminum, cobalt, silver, molybdenum, chromium, tantalum, tungsten, iron, copper and the combination thereof.

22. The comb electrode according to claim 19, wherein the end of said branches approximates the discharge center of said luminant units.
